(19) United States
(12) Patent Application Publication
(10) Pub. No.: US 2025/0349132 A1
(43) Pub. Date: Nov. 13, 2025

(54) METHOD FOR TRAINING A MACHINE LEARNING MODEL FOR DETECTING TRAFFIC LINE MARKINGS

(71) Applicant: Robert Bosch GmbH, Stuttgart (DE)

(72) Inventors: Maximilian Pittner, Erlangen (DE); Alexandru Paul Condurache, Renningen (DE); Joel Janai, Leonberg (DE)

(21) Appl. No.: 19/194,861

(22) Filed: Apr. 30, 2025

(30) Foreign Application Priority Data
May 7, 2024 (DE) 10 2024 204 250.1

(51) Int. Cl. G06V 20/56; G06V 10/82

(52) U.S. Cl. CPC G06V 20/588; G06V 10/82

(57) ABSTRACT

A method for training a machine learning model for detecting traffic line markings. The method includes: providing training data, wherein the training data comprise individual images of traffic scenes having traffic line markings, wherein the individual images result from a capturing by at least one sensor; defining a first cost function, wherein the first cost function describes a degree of correspondence between traffic line markings predicted by the machine learning model and at least one geometric property; and training the machine learning model using the defined first cost function, wherein the machine learning model predicts respective traffic line markings of the individual images of the training data during training, wherein the defined first cost function receives as input the traffic line markings predicted by the machine learning model. A computer program, a device, and a storage medium are also described.

### CROSS REFERENCE

The present application claims the benefit under 35 U.S.C. § 119 of German Patent Application No. DE 10 2024 204 250.1 filed on May 7, 2024, which is expressly incorporated herein by reference in its entirety.

### FIELD

The present invention relates to a method for training a machine learning model for detecting traffic line markings. The present invention furthermore relates to a computer program, a device, and a storage medium for this purpose.

### BACKGROUND INFORMATION

The detection of traffic lines is a fundamental function in the development of driving assistance systems and autonomous vehicles. Machine learning models play a crucial role in this respect by making it possible to recognize the traffic lines from complex and dynamic traffic scenarios. By using deep learning, in particular convolutional neural networks (CNNs), such models can process large amounts of image data captured by cameras on the vehicles.

Learning-based methods for 3D traffic line detection often use neural networks to learn the best possible estimate for the underlying 3D geometry of the traffic lines from image data and corresponding ground truth, for example a true 3D line geometry. Here, for example, a training method is used whose goal is to adjust the parameters present in the neural network in such a way that the line instances present in the particular image are correctly classified and their geometry is approximated as accurately as possible. Here, cost functions are used which describe the classification and regression tasks described above in the form of costs. The better the classification and geometry estimation of the neural network works, the lower the value of the costs described in the cost function. In such purely data-driven approaches, properties of the lane and line geometry along with geometric relationships between the traffic lines are also learned, which are already known (a priori), for example that the majority of the occurring lines run in parallel with one another and have maximum slope and curvature values. Many of these properties have a physical basis (for example, permissible curve radii or transverse inclinations of the lane), which are also specified in the form of official limit values in regulations for road construction and the design of lane markings. In the related art, these properties must be learned using large amounts of data and the necessary accurate ground truth of the 3D line geometry. For example, the neural network is not informed which properties of the lane and line geometry are physically not sensible or not permissible. This can increase the probability that the neural network learns detections with impermissible geometry, which can occur in purely data-driven approaches due to the erroneous learning of outliers (false and/or impermissible ground truth in the data sets).

### SUMMARY

The present invention provides, among other things, a method, a computer program, a device, and a computer-readable storage medium. Features and details of the present invention can be found in the disclosure herein. Features and details that are described in connection with the method according to the present invention of course also apply in connection with the computer program according to the present invention, the device according to the present invention, and the computer-readable storage medium according to the present invention, and vice versa in each case, so that mutual reference can also always be made with regard to the disclosure of the present invention.

The present invention in particular relates to a method for training a machine learning model for detecting traffic line markings. According to an example embodiment of the present invention, the method includes the following steps, wherein the steps can be performed repeatedly and/or successively and in each case can be performed in an automated and/or computer-implemented manner. Traffic line markings are, for example, lines that border a roadway to the outside or lines with interruptions that separate two respective roadways from one another. The machine learning model, for example, is a neural network.

In a first step, training data are preferably provided, wherein the training data comprise individual images of traffic scenes having traffic line markings, wherein the individual images result from a detection by at least one sensor. The individual images can, for example, represent road layouts in traffic scenes, such as a highway, a country road, or a town. The individual images may have been recorded one after the other in a certain order and/or be available as a video. The at least one sensor may be a camera sensor. It is also conceivable that the at least one sensor is a radar, LiDAR, infrared, or ultrasonic sensor so that the individual images can also be implemented as radar, LiDAR, infrared, or ultrasonic images. The at least one sensor can be arranged on a vehicle, which can capture the training data during a journey.

In a further step, a first cost function is preferably defined, wherein the first cost function describes a degree of correspondence between traffic line markings predicted by the machine learning model and at least one geometric property. The at least one geometric property can be an individual geometric property of a single traffic line marking and/or a geometric relationship between at least two traffic line markings, such as a parallelism. The at least one geometric property can be modeled on the basis of defined limit values, in particular official limit values, such as legally prescribed limit values. As a result, using the specified at least one geometric property, prior physical knowledge about the traffic line markings can advantageously be incorporated into the training and thus advantageously does not have to be learned independently by the machine learning model. This allows the machine learning model to be trained faster and more precisely. In particular, the cost function is a differentiable cost function.

In a further step, the machine learning model is preferably trained using the defined first cost function, wherein the machine learning model predicts respective traffic line markings of the individual images of the training data during training, wherein the defined first cost function receives as input the traffic line markings predicted by the machine learning model. Here, the defined first cost function is preferably minimized. In particular, higher costs of the cost function arise if the degree of correspondence between the traffic line markings predicted by the machine learning model and the at least one geometric property is low.

Furthermore, within the scope of the present invention, it is possible that a second cost function, which describes a presence of a traffic line marking in each individual image of the training data, is defined and minimized during training. In other words, the costs incurred are increased if the machine learning model predicts a traffic line marking even though there is no traffic line marking in the corresponding individual image of the training data.

Furthermore, it is possible that the training data comprise a reference geometry for the traffic line markings in the individual images and that a third cost function, which describes a degree of correspondence between the predicted traffic line markings and the reference geometry, is defined and minimized during training. For this purpose, labels can also be provided for the training data, which labels describe the so-called true 3D geometry (ground truth) of the traffic line markings visible in the corresponding individual image, as the reference geometry. The reference geometry can be realized as an ordered list of 3D point coordinates, i.e., in particular as a polyline.

According to a further advantage of the present invention, it can be provided that the at least one geometric property is a parallelism of individual lines of the traffic line markings in the individual images of the training data and that the training comprises the following steps:
sampling points along the traffic line markings,
determining positions of normal point pairs, wherein the normal point pairs are located opposite one another on adjacent traffic line markings orthogonally to a course of the traffic line markings, in particular in the normal direction,
determining tangents at the determined positions of the normal point pairs,
adjusting the tangents on the basis of a corresponding cost function.

This geometric property of parallelism can be modeled by the cost function by first determining the normal point pairs that are opposite one another on adjacent lines in the curve normal direction. For determining these normal point pairs, points at whose positions tangents of the traffic line marking can be calculated in the form of a 3D curve based on the derivatives are preferably sampled along a lane that can be determined by the machine learning model in the individual images of the training data. These tangents, in turn, preferably span normal planes. Subsequently, in particular the intersection points of the normal planes with the adjacent parallel lines are determined. Depending on the line model, the determination of the intersection points can be carried out analytically or approximated numerically by choosing, among discrete points sampled along the curve, the point that has the shortest orthogonal distance to the normal plane. If the tangent pairs have the same direction at the location of the normal point pairs, the line pair at this location is considered in particular to be parallel. The cost function is preferably modeled via a similarity of the tangent pairs at the location of the normal point pairs via a cosine distance. If all tangent pairs of a line pair have a cosine distance of 0, the cost is minimal and the line pair is considered in particular to be parallel. The cost value per line pair is calculated, for example, as the mean value of the cosine distances of all tangent pairs. In this way, the machine learning model can advantageously be trained in an unsupervised manner, i.e., in particular without the need for ground truth data or a reference geometry, in order to predict mainly parallel lines.

It is also optionally possible that the at least one geometric property is a maximum relative transverse inclination of a road surface in the individual images of the training data and that the training comprises the following steps:
sampling points along the traffic line markings,
calculating a respective transverse inclination angle at positions of the points sampled along the traffic line markings,
limiting the respective transverse inclination angles on the basis of a corresponding cost function.

The maximum relative transverse inclination can be modeled as a limit value with the aid of a selectable hyperparameter, depending on the assumption made about the maximum transverse inclination or prescribed officially. Exceedances of these maximum permissible transverse inclinations can be penalized with the aid of the cost function as follows. The points at whose positions the transverse inclination angles are calculated are preferably sampled along the lane determined by the line prediction of the machine learning model. The transverse inclination angles can be determined using surface normals that are determined at normal point pairs of adjacent lanes. The cost function that limits the relative transverse inclination between two roadways can be modeled via the cosine distance of the surface normal. The cost value per roadway pair is calculated, for example, as the mean value of the cosine distances of all surface normals. By defining a limit value for the maximum transverse inclination, the cost function can advantageously be constructed in such a way that only relative transverse inclinations that exceed the set limit value are penalized. In this way, the machine learning model can advantageously be trained in an unsupervised manner, i.e., without the need for ground truth data or a reference geometry, in order to predict only lanes that are continuous to one another and do not exceed certain relative transverse inclination angles. The limitation of the relative transverse inclination angles can be implemented according to selected official limit values, i.e., in particular legally prescribed limit values, by means of an appropriately defined cost function.

Furthermore, it can be advantageous within the scope of the present invention that the at least one geometric property is a maximum slope of a road surface and/or a maximum curvature of the traffic line markings in the individual images of the training data and that the method further comprises the following step:
limiting the slope of the road surface and/or the curvature according to at least one defined limit value.

The at least one defined limit value is in particular an official one, i.e., in particular a legally prescribed limit value. According to official guidelines, the 3D geometry of roadways should be designed in such a way that certain specified limit values with respect to minimum roadway curvature radii and maximum slopes and gradients are not exceeded or undercut. These official limit values can be learned implicitly by the used machine learning model during training by using a corresponding cost function to learn only 3D geometries of officially approved and thus physically meaningful roadways or traffic line markings. This maximum slope and maximum curvature (or minimum curvature radius) can be modeled as limit values with the aid of selectable hyperparameters. These hyperparameters can be determined using official limit values. Since the minimum curvature radius along with maximum slope and gradient values can depend on the maximum permissible speed, the maximum permissible speed value can also be used for ascertaining the hyperparameters. If the limit value is defined via a hyperparameter, the properties of minimum curvature radii along with maximum slopes and gradients can be modeled with the aid of a cost function as follows: The change in the curve (curvature) and in the slope of the currently detected line can be calculated via the change in consecutive tangents (second derivative) with the aid of the cosine distance. If the change in the tangent (curvature or rate of slope) exceeds the specified limit value, this value is preferably set as the cost value in the cost function. The minimization of the cost function therefore corresponds in particular to the suppression of curvature and slope values that exceed the specified limit values. In this way, the machine learning model can be trained in an unsupervised manner, i.e., without the need for ground truth data or a reference geometry, in order to predict only lines whose slope and curvature values do not exceed the a-priori assumed maximum slope and curvature.

According to an advantageous development of the present invention, it can be provided that the at least one geometric property is a position range of the traffic line markings within a three-dimensional space, which is represented by the individual images of the training data, wherein the training comprises the following steps:
defining a three-dimensional reference coordinate system, wherein a position of an ego vehicle forms an origin of the three-dimensional reference coordinate system, wherein the at least one sensor for capturing the individual images of the training data is arranged on the ego vehicle,
determining the position range of the traffic line markings within the three-dimensional space on the basis of the defined three-dimensional reference coordinate system.

In particular, the sensor is arranged on the ego vehicle in such a way that it provides capturing in the driving direction of the ego vehicle, i.e., in simple terms, the sensor is oriented forward. Since roadways and traffic lines are planar objects located on the ground surface, assumptions can be made about their position in three-dimensional space. In particular, the ground surface is located in three-dimensional space only in particular position ranges and is more likely to be located in certain position ranges than in others. Thus, certain a-priori assumptions can be made that reflect in which position ranges the traffic line markings have a higher probability of occurrence and in which an occurrence is rather unlikely. The three-dimensional reference coordinate system used for describing the 3D line position of the traffic line markings can be defined in such a way that the position of the ego vehicle describes the origin of this coordinate system. Since the ego vehicle is located on the ground surface, this results in particular in a-priori assumptions about the height coordinate of the roadway. For the near range (small values in the driving/y-direction), for example, the probability of large absolute z-coordinates of the ground surface (and thus of the roadway and lines) is significantly lower than for small absolute z-coordinates. Since the ground surface can rise or fall along the driving direction, a wider z-range is in particular considered to be likely in the far range. Using these assumptions, the range for the z-position of lines can be defined as a function of the driving direction (y-direction). For this purpose, an upper and lower bound for the possible z-position are preferably modeled in each case as a function, for example as an exponential function. Exceedances of the upper bound and undershoots of the lower bound can then be modeled as costs, in particular by means of L1 and L2 distances. In this way, the machine learning model can advantageously be trained in an unsupervised manner, i.e., without the need for data, in order to predict only lines whose z-positions lie within the a-priori assumed possible height range.

It is possible for the method according to the present invention to be used in a vehicle. The vehicle may be configured, for example, as a motor vehicle and/or passenger vehicle and/or autonomous vehicle. The vehicle may comprise a vehicle mechanism, for example for providing an autonomous driving function, and/or a driver assistance system. The vehicle mechanism may be designed to at least partially automatically control and/or accelerate and/or brake and/or steer the vehicle.

According to an example embodiment of the present invention, the machine learning model is trained in particular for classification and/or object detection. Accordingly, the training can result in a trained machine learning model that can be used for classification and/or object detection. The use and thus the inference can be provided, for example, in a vehicle. The data points of the input data can, for example, be pixels of image data or be based on them in order to perform the classification and/or object detection of the data points on the basis of the pixels. The input data can comprise sensor data and/or image data that result at least partially from capturing with a sensor, preferably a camera sensor, and/or that have been at least partially synthesized, i.e., in particular simulate the real data of a sensor. Specifically, it can be provided that the values of image points, preferably pixels, of the image data represent an environment of a sensor and/or of a vehicle and/or of a traffic scene. A classification, preferably image classification and/or object detection, can be provided on the basis of these values. This makes it possible, for example, to detect objects, in particular the traffic line markings in the traffic scene. The classification can also be provided in the form of semantic segmentation (i.e., a pixel-wise or region-wise classification) and/or an object detection. The image data can, for example, be images from a radar sensor and/or from an ultrasonic sensor and/or from a LiDAR sensor and/or from a thermal imaging camera. Accordingly, the images can also be designed as radar images and/or ultrasound images and/or thermal images and/or lidar images.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be designed as a computer-implemented method.

Further advantages, features and details of the present invention can be found in the following description, in which exemplary embodiments of the present invention are described in detail with reference to the figures. The features mentioned in the description can be essential to the present invention in each case, either individually or in any combination.

### BRIEF DESCRIPTION OF THE DRAWINGS

FIG. 1 is a schematic visualization of a method, of an ego vehicle having a sensor, of a device, of a storage medium, and of a computer program according to exemplary embodiments of the present invention.

FIG. 2 is a schematic representation of an overview of the calculation of parallelism costs for detected traffic line markings.

FIG. 3 is a schematic representation of an overview of the calculation of surface continuity costs for detected lanes.

FIG. 4 is a schematic representation of an overview of the calculation of the costs for maximum slope and curvature values for detected traffic line markings.

FIG. 5 is a schematic representation of a typical height distribution of line points along the driving direction.

### DETAILED DESCRIPTION OF EXAMPLE EMBODIMENTS

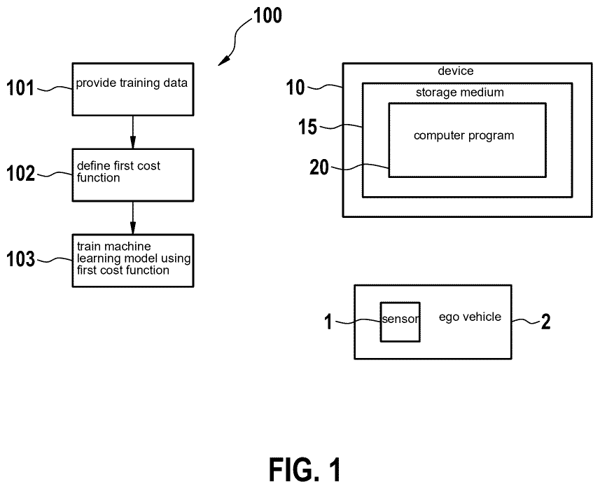

FIG. 1 schematically shows a method 100, an ego vehicle 2 having a sensor 1, a device 10, a storage medium 15, and a computer program 20 according to exemplary embodiments of the invention.

In particular, FIG. 1 shows an exemplary embodiment of a method 100 for training a machine learning model for detecting traffic line markings. In a first step 101, training data are provided, wherein the training data comprise individual images of traffic scenes having traffic line markings, wherein the individual images result from a capturing by at least one sensor 1. In a second step 102, a first cost function is defined, wherein the first cost function describes a degree of correspondence between traffic line markings predicted by the machine learning model and at least one geometric property. In a third step 103, the machine learning model is trained using the defined first cost function, wherein the machine learning model predicts respective traffic line markings of the individual images of the training data during training, wherein the defined first cost function receives as input the traffic line markings predicted by the machine learning model.

The invention according to exemplary embodiments is based in particular on an approach for deep-learning-based 3D detection of traffic line markings. The method serves, for example, to improve existing methods for detecting traffic line markings, which are used for environmental perception for driver assistance systems, e.g., partially to fully automated driving functions. Since the invention according to exemplary embodiments is based on a camera-based detection method, at least one camera sensor is preferably provided as the sensor 1, which is attached to the ego vehicle 2 and is directed forward. In general, the method according to exemplary embodiments is not limited to a single (camera) sensor and can be extended with little adjustment effort so that a plurality of (camera) sensors can be used. For the sake of simplicity, only the case for using a single (camera) sensor is described below.

The image data recorded by the (camera) sensor are preferably processed by a computing unit on which the method according to exemplary embodiments can also be implemented as software. According to exemplary embodiments, the method is based on learning-based detection methods that use neural networks for line detection, i.e., the detection of traffic line markings. The machine learning model used here is in particular a neural network and can be trained on (preferably large) data sets. For this purpose, training data with individual images recorded by a (camera) sensor as described above can be provided. The training data can also be provided with labels that describe the so-called true 3D geometry (ground truth) of the traffic line markings visible in the corresponding image. This description of the 3D geometry of a single line instance can, for example, be realized as an ordered list of 3D point coordinates (polyline).

While the training procedures of already existing methods follow only a data-driven approach, within the scope of the present invention, it is described that physical a-priori (previously given) knowledge about the 3D line geometry in the form of at least one geometric property can be used in the training of the machine learning model to learn a better estimation of the 3D geometry. Since the training is not exclusively data-driven in the method according to exemplary embodiments but can make effective use of a-priori knowledge, the following advantages result. The methodology according to the method of the present invention may be more suitable for generalization. Accordingly, more meaningful estimations or detections can also be achieved in scenarios that are not present in the training data (out-of-domain data) and therefore cannot be learned using purely data-driven approaches. By modeling official limit values, e.g., geometric properties of the roadway (maximum slopes, transverse inclinations) or speed limits, the machine learning model can learn rules about road conditions and traffic during training. It is thus ensured that the machine learning model used does not generate arbitrary detections when used in road traffic, but that the recognized traffic line markings always have physically meaningful properties that are valid according to official regulations. Generating accurate 3D ground truth, which is usually present in the training data, can be particularly difficult and depends on the quality of offline detection methods used for the generation. This can lead to the 3D ground truth often being inaccurate and sometimes noisy. In contrast, the quality within the scope of the present invention in particular does not depend exclusively on the quality of the 3D ground truth used during training. This property can represent a significant advantage over purely data-driven approaches. In particular, by modeling certain geometric properties on the basis of previously given knowledge about the 3D line geometry, it is in particular no longer necessary to learn these properties from the given 3D data. During training, the machine learning model can thus focus on estimating difficult 3D line geometry in more complex scenarios, given in the data, that are not modeled by the a-priori knowledge.

The geometric properties can be learned by the machine learning model without the presence of 3D data by defining certain cost functions that describe the fact that certain geometric properties via a-priori geometry knowledge apply to the lines predicted by the machine learning model. In other words, the cost function describes in particular a degree of correspondence between traffic line markings predicted by the machine learning model and at least one geometric property. These cost functions are preferably minimized during training and require as input values only the predictions of the traffic line markings performed by the machine learning model. Since no ground truth is needed to minimize these costs, the machine learning model can learn a 3D line geometry of the traffic line markings in an unsupervised manner. In addition to the costs of learning a-priori geometry knowledge, costs can also be minimized that describe the presence of the respective traffic line markings (classification) and a degree of correspondence between traffic line markings predicted by the machine learning model and the ground truth, i.e., the reference geometry (regression), as can often be the case in supervised learning methods.

Within the scope of the present invention, in particular (differentiable) cost functions are defined the minimization of which reflects the fact that certain geometric properties of 3D line geometry of the traffic line markings apply better, along with the training method that forces the minimization of these cost functions.

The following geometric properties of the 3D line geometry of the traffic line markings can be defined or modeled as a cost function within the scope of the method according to exemplary embodiments.

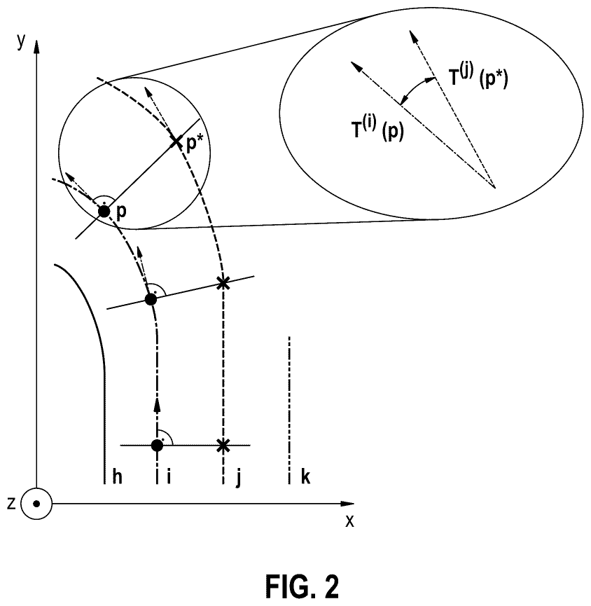

A first geometric property is, in particular, parallelism within certain groups of lines. Traffic line markings that belong to a roadway and follow its course (e.g., guidelines, solid lines, boundary markings) in particular usually run partially or completely in parallel with one another in three-dimensional space. This geometric property of parallelism can be modeled by the cost function by first determining the normal point pairs that are opposite one another on adjacent lines in the curve normal direction. For determining these normal point pairs, points at whose positions tangents of the traffic line marking can be calculated in the form of a 3D curve based on the derivatives are preferably sampled along a lane that can be determined by the machine learning model in the individual images of the training data. These tangents, in turn, preferably span normal planes (see FIG. 2). Subsequently, preferably the intersection points of the normal planes with the adjacent parallel lines are determined. Depending on the line model, the determination of the intersection points can be carried out analytically or approximated numerically by choosing, among discrete points sampled along the curve, the point that has the shortest orthogonal distance to the normal plane. If the tangent pairs have the same direction at the location of the normal point pairs, the line pair at this location is considered in particular to be parallel. The cost function is preferably modeled via a similarity of the tangent pairs at the location of the normal point pairs via a cosine distance (see FIG. 2). If all tangent pairs of a line pair have a cosine distance of 0, the cost is minimal and the line pair is considered in particular to be parallel. The cost value per line pair is calculated, for example, as the mean value of the cosine distances of all tangent pairs. In this way, the machine learning model can advantageously be trained in an unsupervised manner, i.e., in particular, without the need for data, in order to predict mainly parallel lines.

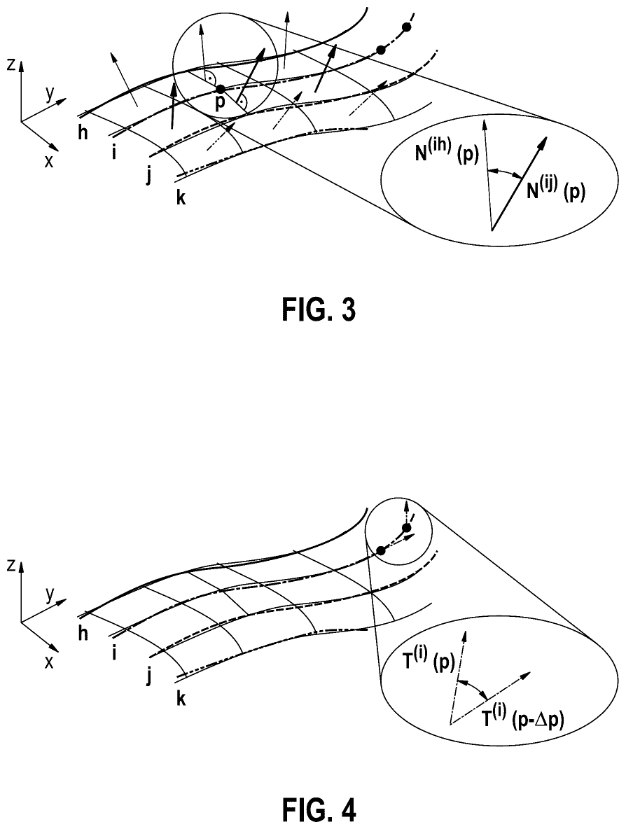

A second geometric property is in particular a continuity of the road surface or a transverse inclination of the roadway. In particular, adjacent lanes have a maximum relative transverse inclination to one another in three-dimensional space since the road surface is continuous and should not contain any discontinuities. This maximum relative transverse inclination can be modeled as a limit value with the aid of a selectable hyperparameter, depending on the assumption made about the maximum transverse inclination or prescribed officially. Exceedances of these maximum permissible transverse inclinations can be penalized with the aid of the cost function according to exemplary embodiments as follows. Along the lane determined by the line prediction of the machine learning model, the points at whose positions the transverse inclination angles are calculated are preferably sampled. The transverse inclination angles can be determined using surface normals that are determined at normal point pairs of adjacent lanes (see FIG. 3). The cost function that limits the relative transverse inclination between two roadways can be modeled (analogously to parallelism) via the cosine distance of the surface normal. It is in particular important to note that the cost function can have the same effect as minimizing the relative transverse inclination angle between roadways. The cost value per roadway pair is calculated, for example, analogously to the parallelism costs, as the mean value of the cosine distances of all surface normals. By defining a limit value for the maximum transverse inclination, the cost function can advantageously be constructed in such a way that only relative transverse inclinations that exceed the set limit value are penalized. In this way, the machine learning model can advantageously be trained in an unsupervised manner, i.e., without the need for data, in order to predict only lanes that are continuous with one another and do not exceed certain relative transverse inclination angles.

A third geometric property is in particular a maximum slope of a road surface and/or a maximum curvature of the traffic line markings. According to official guidelines, the 3D geometry of roadways should be designed in such a way that certain specified limit values with respect to minimum roadway curvature radii and maximum slopes and gradients are not exceeded or undercut. These official limit values can be learned implicitly by the used machine learning model during training by using a corresponding cost function to learn only 3D geometries of officially approved and thus physically meaningful roadways or traffic line markings. This maximum slope and maximum curvature (or minimum curvature radius) can be modeled as limit values with the aid of selectable hyperparameters. These hyperparameters can be determined using official limit values. Since the minimum curvature radius along with maximum slope and gradient values can depend on the maximum permissible speed, the maximum permissible speed value can also be used for ascertaining the hyperparameters. If the limit value is defined via a hyperparameter, the properties of minimum curvature radii along with maximum slopes and gradients can be modeled with the aid of a cost function as follows: The change in the curve (curvature) and in the slope of the currently detected line can be calculated via the change in consecutive tangents (second derivative) with the aid of the cosine distance (see FIG. 4). If the change in the tangent (curvature or rate of slope) exceeds the specified limit value, this value is preferably set as the cost value in the cost function. The minimization of the cost function therefore corresponds in particular to the suppression of curvature and slope values that exceed the specified limit values. In this way, the machine learning model can be trained in an unsupervised manner, i.e., without the need for data, in order to predict only lines whose slope and curvature values do not exceed the a-priori assumed maximum slope and curvature. Limit values for the maximum curvature can be specified via minimum curve radii, which are specified, for example, in “Transportation Officials. A Policy on Geometric Design of Highways and Streets, 2011. AASHTO, 2011.”

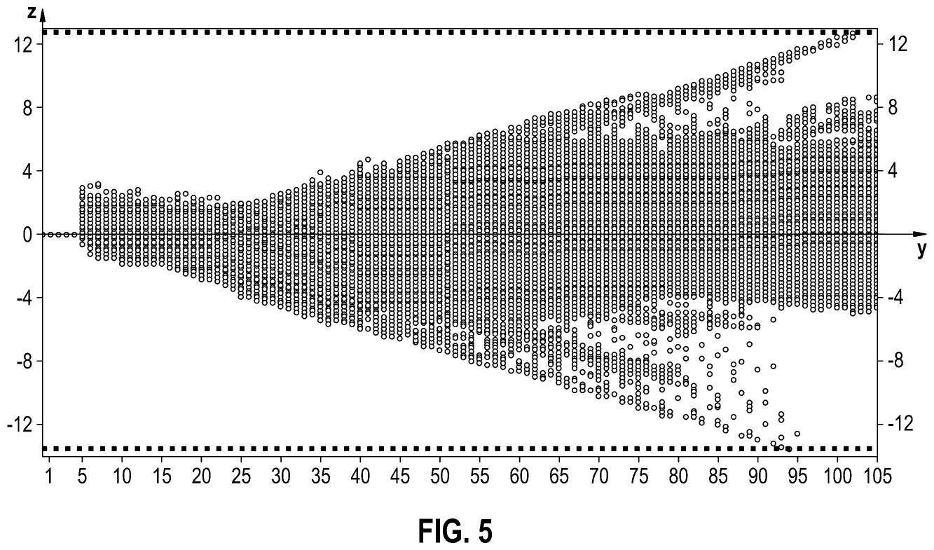

A third geometric property is in particular a position range of the traffic line markings within a three-dimensional space. Since roadways and traffic lines are planar objects located on the ground surface, assumptions can be made about their position in three-dimensional space. In particular, the ground surface is located in three-dimensional space only in particular position ranges and is more likely to be located in certain position ranges than in others. Thus, certain a-priori assumptions can be made that reflect in which position ranges the traffic line markings have a higher probability of occurrence and in which an occurrence is rather unlikely. The three-dimensional reference coordinate system used for describing the 3D line position of the traffic line markings can be defined in such a way that the position of the ego vehicle describes the origin of this coordinate system. Since the ego vehicle is located on the ground surface, this results in particular in a-priori assumptions about the height coordinate of the roadway. For the near range (small values in the driving/y-direction), for example, the probability of large absolute z-coordinates of the ground surface (and thus of the roadway and lines) is significantly lower than for small absolute z-coordinates (see FIG. 5). Since the ground surface can rise or fall along the driving direction, a wider z-range is in particular considered to be likely in the far range. Using these assumptions, the range for the z-position of lines can be defined as a function of the driving direction (y-direction). For this purpose, an upper and lower bound for the possible z-position are preferably modeled in each case as a function, for example as an exponential function. Exceedances of the upper bound and undershoots of the lower bound can then be modeled as costs, in particular by means of L1 and L2 distances.

In particular, the L1 distance between two points in an n-dimensional space is the sum of the absolute differences of their coordinates. Mathematically, the L1 distance between two points x=(x₁, x₂, . . . , xₙ) and y=(y₁, y₂, . . . , yₙ) is defined as:

$$‖ x - y ‖ = {\sum }_{i = 1}^{n} \vert {x}_{i} - {y}_{i} \vert$$

In particular, the L2 distance is a distance metric that measures the direct or straight-line distance between two points in a Euclidean space. It corresponds to the length of the hypotenuse segment in a right-angled triangle that connects the two points. Mathematically, the L2 distance between the points x and y, for example, is defined as follows:

$$‖ x - y ‖ = \sqrt{{\sum }_{i = 1}^{n} {( {x}_{i} - {y}_{i} )}^{2}}$$

In this way, the machine learning model can be trained in an unsupervised manner, i.e., without the need for data, in order to predict only lines whose z-positions lie within the a-priori assumed possible height range.

The above-mentioned properties are preferably calculated in each training iteration based on a current output of the machine learning model as described, which results in particular in the following term for the total cost of the a-priori geometry:

$${ℒ}_{prior} = {λ}_{par} {ℒ}_{par} + {λ}_{cont} {ℒ}_{cont} + {λ}_{curv} {ℒ}_{curv} + {λ}_{pos} {ℒ}_{pos}$$

The total costs that are minimized during training then result, for example, from the weighted sum of the detection costs (supervised part) and the a-priori geometry costs defined here (unsupervised part), as follows:

$$ℒ = {λ}_{class} {ℒ}_{class} + {λ}_{reg} {ℒ}_{reg} + {λ}_{prior} {ℒ}_{prior}$$

In particular, FIG. 2 shows an overview of the calculation of parallelism costs for detected traffic line markings, shown in a plan view. For calculating the parallelism costs, normal point pairs (p, p*) of a line pair (i, j) are preferably first determined with the aid of the normal plane. Subsequently, the cosine distances of the tangent pairs (T) at the location (p, p*) are preferably minimized in order to force parallel line pairs.

In particular, FIG. 3 shows an overview of the calculation of surface continuity costs for detected lanes, shown in 3D. For the calculation, the adjacent surface normals (N) are preferably determined and their cosine distances are minimized up to a set limit value in order to limit the relative transverse inclination angles between lanes and thus obtain surface continuity.

In particular, FIG. 4 shows an overview of the calculation of the costs for maximum slope and curvature values for detected traffic line markings, shown in 3D. For the calculation, the tangents for consecutive points of a line are preferably calculated and their cosine distance is minimized up to a set limit value in order to limit the slope and curvature values of detected lines.

FIG. 5 shows, by way of example, a typical height distribution (z) of line points along the driving direction (y). The points in particular show line coordinates for an example data set for 3D line and lane detection; the dashed lines in particular show maxima and the z-coordinate.

The above description of the embodiments describes the present invention exclusively in the context of examples. Of course, individual features of the embodiments, provided they make technical sense, can be freely combined with one another without departing from the scope of the present invention.

What is claimed is:

1. A method for training a machine learning model for detecting traffic line markings, the method comprising the following steps:
providing training data, wherein the training data include individual images of traffic scenes having traffic line markings, wherein the individual images result from a capturing by at least one sensor;
defining a first cost function, wherein the first cost function describes a degree of correspondence between traffic line markings predicted by the machine learning model and at least one geometric property; and
training the machine learning model using the defined first cost function, wherein the machine learning model predicts respective traffic line markings of the individual images of the training data during training, wherein the defined first cost function receives as input the traffic line markings predicted by the machine learning model.

2. The method according to claim 1, wherein a second cost function, which describes a presence of a traffic line marking in each individual image of the training data, is defined and minimized during training.

3. The method according to claim 1, wherein the training data include a reference geometry for the traffic line markings in the individual images, and wherein a third cost function, which describes a degree of correspondence between the predicted traffic line markings and the reference geometry, is defined and minimized during training.

4. The method according to claim 1, wherein the at least one geometric property is a parallelism of individual lines of the traffic line markings in the individual images of the training data, and the training includes the following steps:
sampling points along the traffic line markings,
determining positions of normal point pairs, wherein the normal point pairs are located opposite one another on adjacent traffic line markings orthogonally to a course of the traffic line markings,
determining tangents at the determined positions of the normal point pairs, and
adjusting the tangents based on a corresponding cost function.

5. The method according to claim 1, wherein the at least one geometric property is a maximum relative transverse inclination of a road surface in the individual images of the training data, and wherein the training includes the following steps:
sampling points along the traffic line markings,
calculating a respective transverse inclination angle at positions of the points sampled along the traffic line markings, and
limiting the respective transverse inclination angles based on a corresponding cost function.

6. The method according to claim 1, wherein the at least one geometric property is a maximum slope of a road surface and/or a maximum curvature of the traffic line markings in the individual images of the training data, and wherein the method further comprises the following step:
limiting a slope of the road surface and/or a curvature of the traffic lane markings according to at least one defined limit value.

7. The method according to claim 1, wherein the at least one geometric property is a position range of the traffic line markings within a three-dimensional space, which is represented by the individual images of the training data, wherein the training includes the following steps:
defining a three-dimensional reference coordinate system, wherein a position of an ego vehicle forms an origin of the three-dimensional reference coordinate system, wherein the at least one sensor for capturing the individual images of the training data is arranged on the ego vehicle, and
determining the position range of the traffic line markings within the three-dimensional space based on the defined three-dimensional reference coordinate system.

8. A non-transitory computer-readable storage medium on which is stored a computer program comprising commands for training a machine learning model for detecting traffic line markings, the commands, when executed by a computer, causing the computer to perform the following steps:
providing training data, wherein the training data include individual images of traffic scenes having traffic line markings, wherein the individual images result from a capturing by at least one sensor;
defining a first cost function, wherein the first cost function describes a degree of correspondence between traffic line markings predicted by the machine learning model and at least one geometric property; and
training the machine learning model using the defined first cost function, wherein the machine learning model predicts respective traffic line markings of the individual images of the training data during training, wherein the defined first cost function receives as input the traffic line markings predicted by the machine learning model.

9. A device for processing data configured to train a machine learning model for detecting traffic line markings, the device configured to:
provide training data, wherein the training data include individual images of traffic scenes having traffic line markings, wherein the individual images result from a capturing by at least one sensor;
define a first cost function, wherein the first cost function describes a degree of correspondence between traffic line markings predicted by the machine learning model and at least one geometric property; and
train the machine learning model using the defined first cost function, wherein the machine learning model predicts respective traffic line markings of the individual images of the training data during training, wherein the defined first cost function receives as input the traffic line markings predicted by the machine learning model.
